(19) United States
(12) Patent Application Publication
(10) Pub. No.: US 2022/0221980 A1
(43) Pub. Date: Jul. 14, 2022

(54) COMPUTER-ASSISTED MOBILE APP IMPLEMENTATION AND OPERATION

(71) Applicant: CARDTAPP, INC., Bellevue, WA (US)

(72) Inventors: Benjamin David Brashen, Kirkland, WA (US); Dustin David Swisstack, Mukilteo, WA (US)

(21) Appl. No.: 17/146,114

(22) Filed: Jan. 11, 2021

(51) Int. Cl. G06F 3/0484; H04L 29/08

(52) U.S. Cl. CPC G06F 3/04842; H04L 67/10; G06F 3/04845

(57) ABSTRACT

A facility for maintaining a state of a distributed mobile app is described. The facility stores data identifying configuration options specified for configuring the distributed mobile app. The facility also stores data indicating, for each of a plurality of users of the distributed mobile app, actions taken by the user with respect to the distributed mobile app.

### BACKGROUND

Mobile apps are constructed by a process in which a number of components are designed, implemented, integrated, tested, and maintained: overall operation of the app; client user interface; and backend storage and processing, as examples. It is common for these processes to be performed by people who rely on specialized skills, training, and resources.

### BRIEF DESCRIPTION OF THE DRAWINGS

FIG. 1 is a block diagram showing some of the components typically incorporated in at least some of the computer systems and other devices on which the facility operates.

FIG. 2 is a flow diagram showing a process performed by the facility in some embodiments in order to perform computer-assisted mobile app implementation and operation.

FIG. 3 is a display diagram showing a sample display presented by the facility in some embodiments that can be used in the process of creating a template.

FIG. 4 is a display diagram showing a sample display presented by the facility in some embodiments to continue the creation of a template.

FIG. 5 is a display diagram showing a sample display presented by the facility in some embodiments to define app defaults details of a template.

FIG. 6 is a display diagram showing a sample display presented by the facility to edit default contents for a group of registration fields.

FIG. 7 is a display diagram showing a sample display presented by the facility in some embodiments to set permissions for the app template.

FIG. 8 is a display diagram showing a sample display presented by the facility in some embodiments to add documents to an app template.

FIG. 9 is a display diagram showing a sample display presented by the facility in some embodiments to add to an app template app pages.

FIG. 10 is a display diagram showing a sample display presented by the facility in some embodiment to add controls such as links or buttons to an app template.

FIG. 11 is a display diagram showing a sample display presented by the facility in some embodiments to further customize the design of a mobile app.

FIG. 12 is a display diagram showing a sample display presented by the facility in some embodiments to enable a domain expert to update details of the configuration of the XYZ Auto Parts app.

FIG. 13 is a display diagram showing a sample display displayed by the facility in some embodiments to perform the second phase of the app definition process.

FIG. 14 is a display diagram showing a sample display presented by the facility in some embodiments in connection with the third phase of the app definition process.

FIG. 15 is a display diagram showing a sample display presented by the facility in some embodiments to configure events for the app.

FIG. 16 is a display diagram showing a sample display presented by the facility in some embodiments to enable a domain expert to specify tag definitions for users of the app.

FIG. 17 is a display diagram showing a sample display presented by the facility in some embodiments as part of the execution of the app whose definition is discussed above.

FIG. 18 is a display diagram showing a sample display presented by the facility in some embodiments to enable the creation of a text messaging, or “SMS”, campaign for the app.

FIG. 19 is a display diagram showing a sample display presented by the facility in some embodiments in order to permit a domain user to specify a campaign limited to users to whom a certain tag has been attributed.

FIG. 20 is a display diagram showing a sample display presented by the facility in some embodiments to specify how lead scores are determined for each user of the app.

FIG. 21 is a display diagram showing a sample display presented by the facility in some embodiments to further define the app.

FIG. 22 is a display diagram showing a sample SMS message sent to each prospective user of a particular app.

FIG. 23 is a display diagram showing a sample display in which the prospective user has used the response controls to send an SMS reply to the facility's solicitation message.

FIG. 24 is a display diagram showing a sample display presented by the facility in some embodiments to permit an agent working in connection with the facility to correspond with users and prospective users of the app.

FIG. 25 is a display diagram showing a sample display presented by the facility in some embodiments as part of the execution of the app on the device of an enrolled user.

FIG. 26 is a display diagram showing a sample display presented by the facility in some embodiments to schedule an ad hoc SMS campaign.

FIG. 27 is a display diagram showing a sample display presented by the facility in some embodiments to specify information for a new campaign.

FIG. 28 is a display diagram showing a sample display presented by the facility in some embodiments to present a popup window for specifying the users who will receive a new campaign's message.

FIG. 29 is a display diagram showing a sample display presented by the facility in some embodiments to provide a dashboard for agents working in connection with the facility.

FIG. 30 is a display diagram showing a sample display presented by the facility in some embodiments in order to enable an agent or other person working with respect to the facility to specify an auto responder message to be sent in response to some or all user message received while the auto responder toggle is switched on.

FIG. 31 is a display diagram showing a sample display presented by the facility in some embodiments in order to provide a user evaluation dashboard to an agent, as a basis for the agent taking action to contact or otherwise follow up with particular users.

FIG. 32 is a display diagram showing a sample display presented by the facility in some embodiments to examine in more detail the information about a particular user.

### DETAILED DESCRIPTION

The inventors have recognized that conventional approaches to constructing mobile apps have significant disadvantages. In particular, the technical experts needed to design and construct the app tend to be rare and expensive to engage. Also, producing a useful, well-functioning app typically requires that these technical experts communicate thoroughly and effectively with domain experts who understand the subject matter of the app and contribute that understanding to make the app useful for its intended purpose. Further, it can be difficult for the operator of an app to learn about users' use of the app, and communicate with them appropriately about that use.

In response to recognizing these disadvantages, the inventors have conceived and reduced to practice a software and/or hardware facility that provides meaningful automatic assistance to the process of implementing and operating a mobile app (“the facility”).

The facility provides a user interface that a domain expert can straightforwardly use to (1) configure a mobile app for a particular group of users; (2) announce to those users the availability of the app for their installation and use; (3) track the users' use of and interactions with the app; and (4) identify users well-suited to various communications about their use of the app.

In some embodiments, the configuration performed by the facility includes, for example, causing the app to display identifying information for the group of users, selecting the controls that will be displayed by the app, collecting documents or other resources that will be made available to the users via the app, etc. In some embodiments, the facility enables the domain expert to select a template specifying many of these configuration details, then add or substitute additional details coordinated to the user group. In some embodiments, the user interface shows a preview of how the app will appear based upon the current set of configurations, which is updated to reflect additional configuration choices as they are made.

In some embodiments, the deployment performed by the facility involves the bulk input of contact information for the group of users, and use of that contact information to transmit messages to the users inviting them to install the app. In some embodiments, the tracking performed by the facility involves detecting some or all of each user's interactions with the app and storing them in a backend for analysis.

In some embodiments, the facility analyzes the user interaction information to identify users that have interacted with the app in one or more particular patterns. In particular, in some embodiments, matches users' interactions with these patterns, and communicates with the qualifying users in response, in either an automatic or semi-automatic manner. In some embodiments, the facility enables domain experts to define these patterns, and ways in which the app should communicate with the qualifying users.

By performing in some or all of these ways, the facility enables domain experts to construct and deploy an app configured for a group of users, track and analyze their use of the app, and contact them in a way responsive to the analysis, all without performing any programming.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by configuring apps based on templates, the facility reduces the user interactions needed to perform a complete configuration. Thus, configuration can be performed with a less powerful and less expensive processor, or one that undertakes more or larger simultaneous processing tasks.

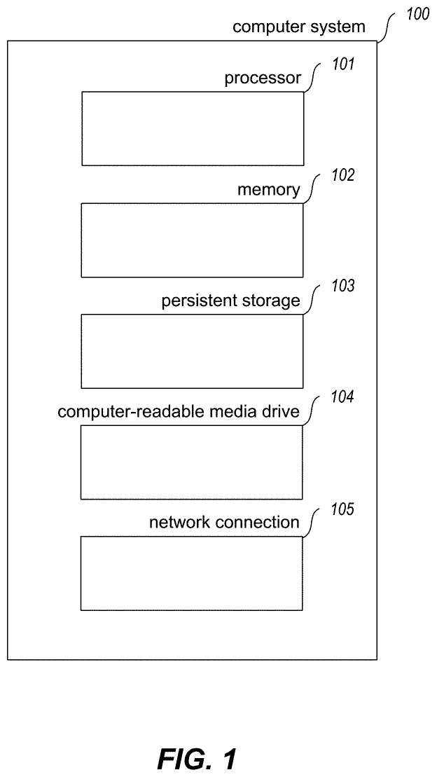

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types, having various components, and being configured in various ways.

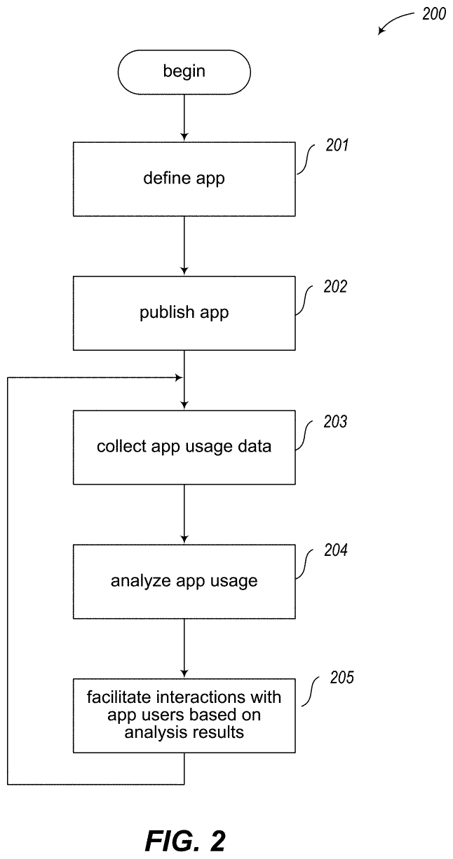

FIG. 2 is a flow diagram showing a process performed by the facility in some embodiments in order to perform computer-assisted mobile app implementation and operation. In act 201, the facility defines the app, based upon input from a person such as a domain expert. The facility receives input from the domain expert, and establishes configuration details that define the app. In some embodiments, the domain expert can select and/or define a template that is the basis for defining the app. The template has certain configuration details, which can be overwritten in the process of modifying or configuring the template to define the app.

In act 202, the facility publishes the app. In some embodiments, this involves sending to the members of the group an SMS text message containing a link for installing the app on their mobile devices. In some embodiments, act 202 involvesautonomously installing the app on the mobile devices of users in the group. In some embodiments, the facility performs act 202 based on input from the domain expert such as the schedule for publishing the app, message content to be used in the invitation, identifying and contact information for users in the group, etc. In act 203, the facility collects usage data reflecting use of the app by some or all of the users in the group. In act 204, the facility analyzes the app usage data collected in act 203. In some embodiments, this involves counting or otherwise aggregating usage events from each user in the group. It also involves comparing the aggregated information for each user to a number of patterns each defining a tag that can characterize a user. For each pattern that is matched by the aggregated usage data from the user, the corresponding tag is attributed to the user as a way of characterizing the user, their actions, their intentions, etc., in a way that relates to following up with the user. In act 205, the facility facilitates the interactions with the users based upon the results of the analysis performed in act 204. In various embodiments, this involves displaying messages to users in the app; autonomously sending messages via a different modality such as SMS message, email message, etc., to the user; prompting and assisting human follow-up agents to generate and send such messages; etc. After act 205, the facility continues in act 203 to collect and analyze additional usage data, which can be used to facilitate additional interactions.

Those skilled in the art will appreciate that the acts shown in FIG. 2 may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

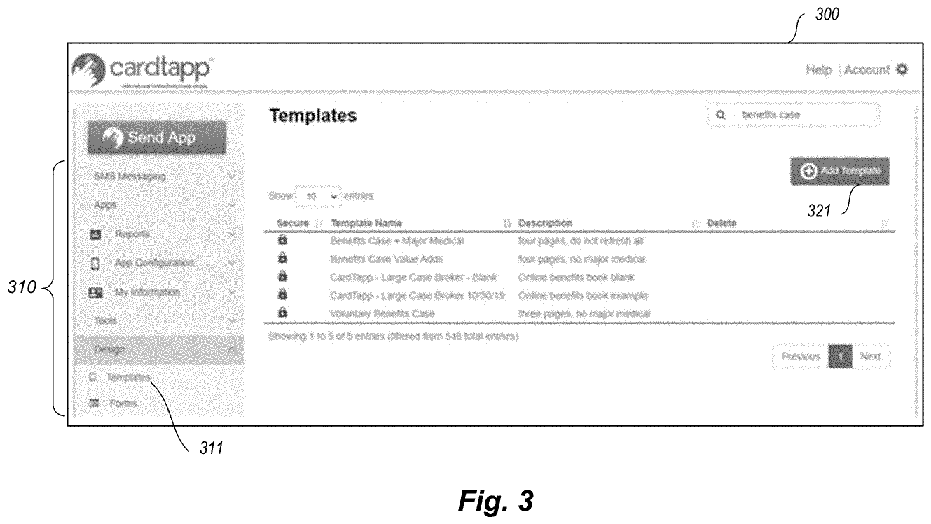

FIGS. 3-31 are display diagrams showing aspects of the user interface provided by the facility to domain experts creating and distributing an app, and reviewing and acting on a users' use of the app. In various embodiments, the facility is usable to build and operate apps in a wide variety of problem domains. The example app that is shown in the display diagrams discussed below, directed to helping a group of people who are eligible for certain employment benefits to understand those benefits and elect among them, is simply illustrative.

FIGS. 3-10 show displays presented by the facility in some embodiments in the process of constructing an app template that can be used as a basis to define multiple apps that are similar in various respects, but differ in others, such as the identity, nature, and contact information of the organization to which the users belong; details of the particular benefits that are available; etc. FIG. 3 is a display diagram showing a sample display presented by the facility in some embodiments that can be used in the process of creating a template. The display 300 includes a navigation bar 310 containing controls corresponding to different aspects of the facility. To reach this display, the user has clicked on or otherwise selected a “Templates” control 311. In response, the facility displays a list of five existing templates. In some embodiments, the user can click or otherwise select one of these existing templates to begin defining an app that is based on the template. The display also includes an add template control 321 that the user can select in order to begin a process of creating a new template.

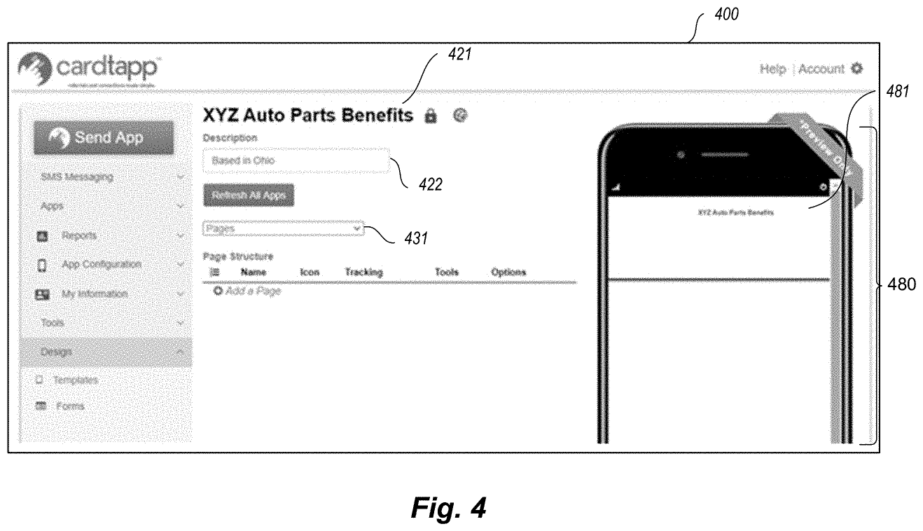

FIG. 4 is a display diagram showing a sample display presented by the facility in some embodiments to continue the creation of a template. The user can enter a template name 421 as a well as a description 422 for the template. The display also includes a drop down menu 431 in which the user can choose among different aspects of the template to specify. The display further includes a visual mockup pane 480 that it uses throughout the template definition and app definition processes to show how the current configuration of the template or app will be reflected in an installed version of the app. In particular, it can be seen that the template name 421 is shown in a mockup as item 481. In the example, the user opens drop down menu 431 to select an “app defaults” aspect of the template definition in place of the former “pages” aspect.

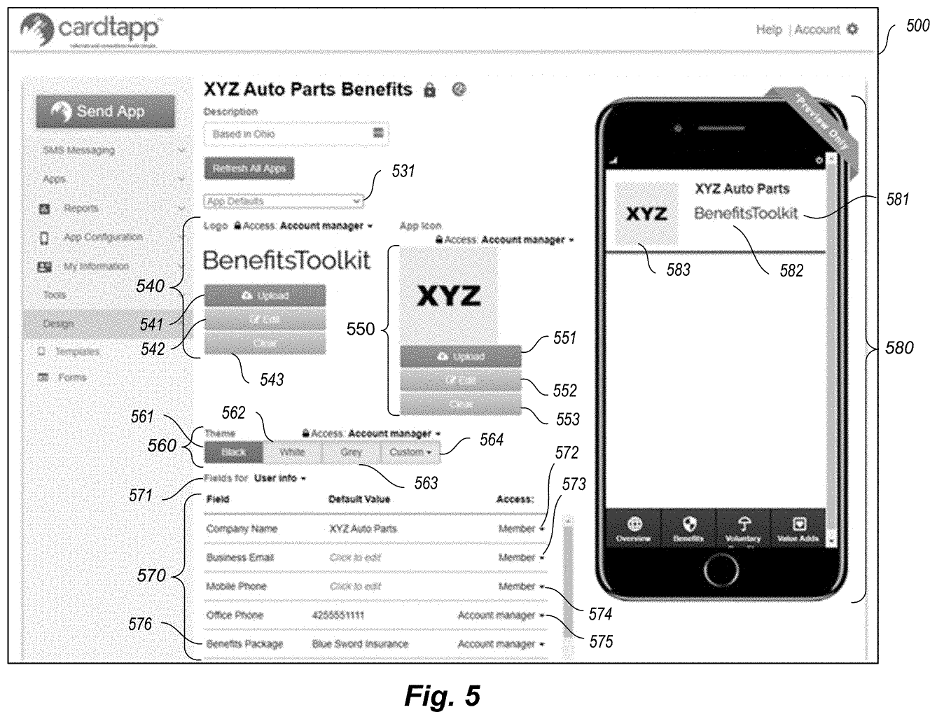

FIG. 5 is a display diagram showing a sample display presented by the facility in some embodiments to define app defaults details of a template. The display 500 allows the user to specify images to be displayed in the app, as well as fields such as headings, phone numbers, and theme colors. Field 531 shows that app defaults are presently being specified in the display. Section 540 enables the user to specify a logo image for use in the app. In some embodiments, the specified logo image is displayed for at least part of the time that the app is executing. It includes controls 541-543 for uploading, editing, and clearing the logo image. It also includes a preview of the logo image. Similarly, section 550 has contents usable to specify an icon for the app. In some embodiments, the icon is displayed at least some of the time that the app is executing, as well as in menus or lists of apps installed on the mobile device that are available to launch. Section 550 contains controls 551-553 for uploading, editing, and clearing the icon, respectively, as well as a preview of the specified icon. Section 560 allows the user to specify a color theme for the app. It can be seen, among available color themes 561-564, the black color theme is selected. Control 571 selects a category of fields for which the user can enter values. It can be seen that user info fields are presently selected. The display also includes a list 570 of user info fields, together with their default values, and their access control limits. For example, it can be seen from item 575 in the list that the “office phone” field has default value “425 555 1111,” and is accessible to a person in the role of “account manager.”

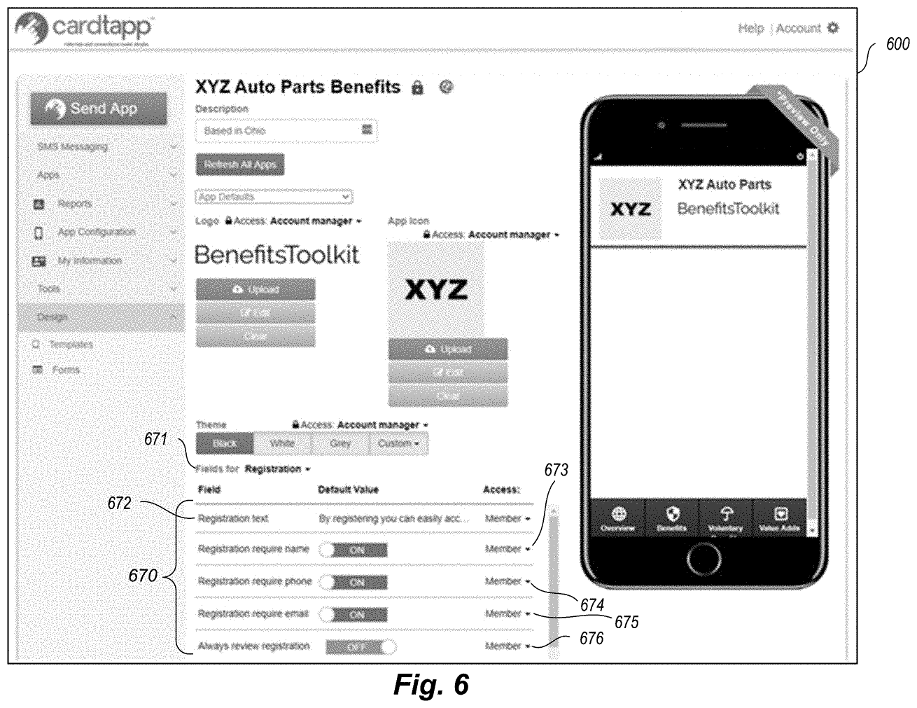

FIG. 6 is a display diagram showing a sample display presented by the facility to edit default contents for a group of registration fields. In display 600 it can be seen that control 671 is set to view a group of registration fields. These are shown in list 670, and can be edited there by the user. These are fields that a user of the app enters when registering with the app. Each could be either required or optional based on the app's definition. The registration text field 672 contains text that can be edited by the domain expert to explain to the user the need for the information requested of the user, which can be edited by the domain expert. Rows 673-676 each show a field that can be solicited of the app's user, such as name field in row 673, phone number field in 674, etc. Each of these rows contains in its center a toggle that the domain expert can switch in order to either make the field either required or optional. Because the switch is on in rows 673-675, each of the fields name, phone, and email are required.

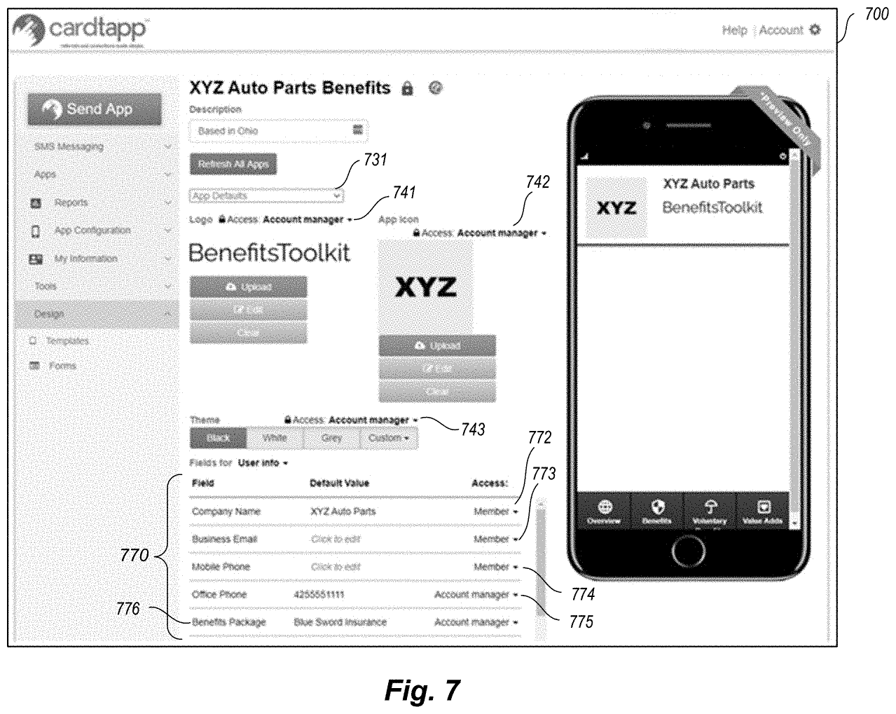

FIG. 7 is a display diagram showing a sample display presented by the facility in some embodiments to set permissions for the app template. In the display 700, it can be seen that the logo section has an access control drop down menu 741 in which the domain expert can specify the permission level for the logo—that is, the permission level needed in order to be able to modify this portion of the app configuration. It can be seen that the permission level specified for the logo is “account manager.” The icon has a similar control 742, and the theme a similar control 743. Additionally, the fields in the user information fields list 770 each have such a control. For example, the mobile phone field shown in row 774 of the list has its permission level set to “member.” Each of these can be changed by the domain expert editing the template.

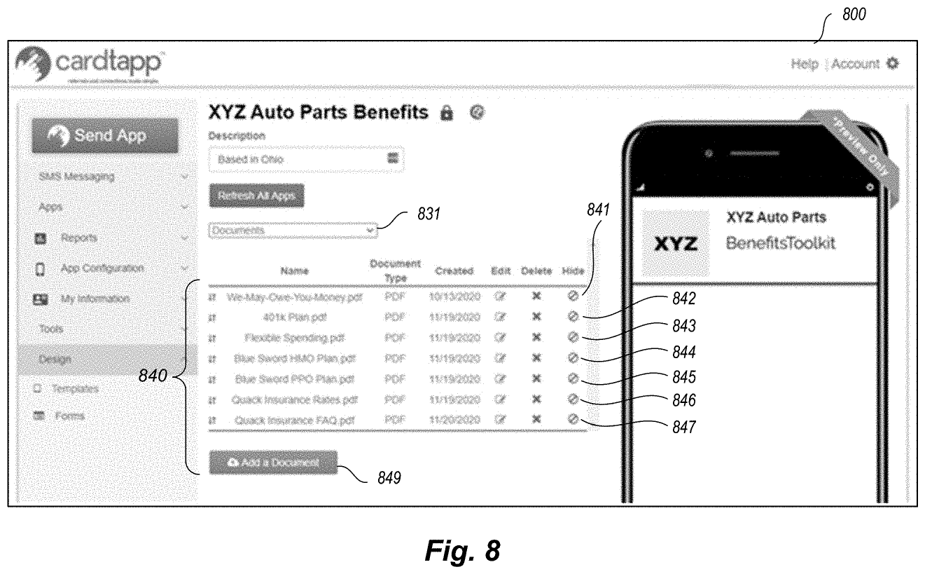

FIG. 8 is a display diagram showing a sample display presented by the facility in some embodiments to add documents to an app template. In the display 800, it can be seen that the domain expert has selected “documents” in control 831. As a result, a list 840 of documents made available in the app is displayed. For each document, a row shows the document's name, type, and creation date. Additionally, each row contains a control to edit the document, delete the document form the list and app, or hide the document so that it will not appear in the app, but will remain in the list and can be unhidden later. For example, row 843 contains information about a 401Kplan.pdf document, having document type PDF and creation date Nov. 19, 2000. Additionally, the display includes a control 849 that can be activated to add a document to the list.

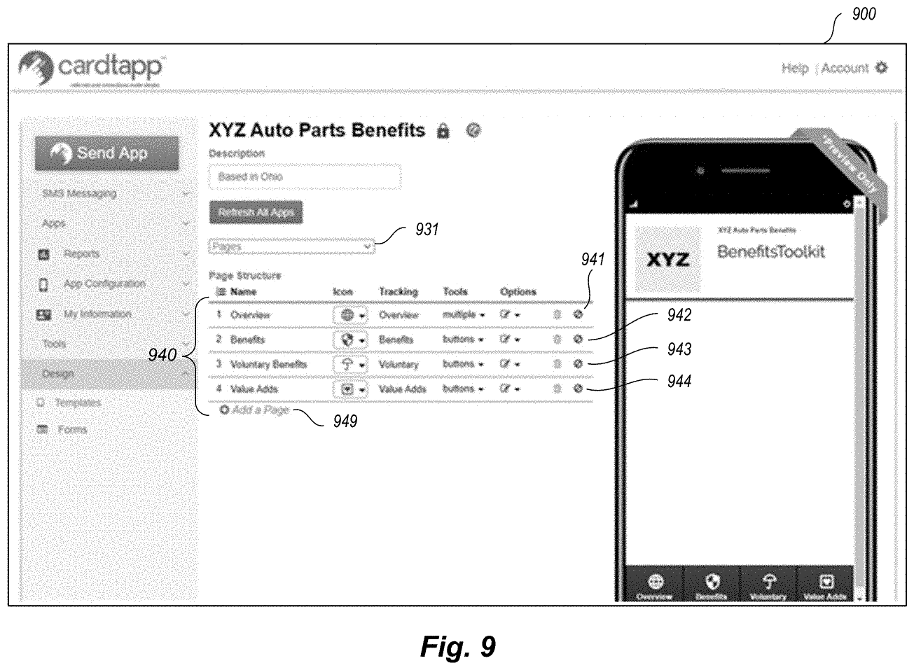

FIG. 9 is a display diagram showing a sample display presented by the facility in some embodiments to add to an app template app pages. It can be seen that the domain expert has selected “pages” in control 931. As a result, list 940 of the pages presently specified for the app by the app template is displayed. For each page, the list contains the page's name, an icon that will be displayed by the app as a basis for navigating to the page from a page menu, a tracking value that will be used to monitor each app user's visits to the page, tools that specify controls to be included on the page, options for the page, and controls for either deleting the page or suspending the inclusion of the page in the app while keeping it in the list. For example, row 943 shows that a “voluntary benefits” page will have an umbrella icon, a tracking name of “voluntary,” button controls, and various options. The display also includes a control 949 that can be activated to add a page to the app.

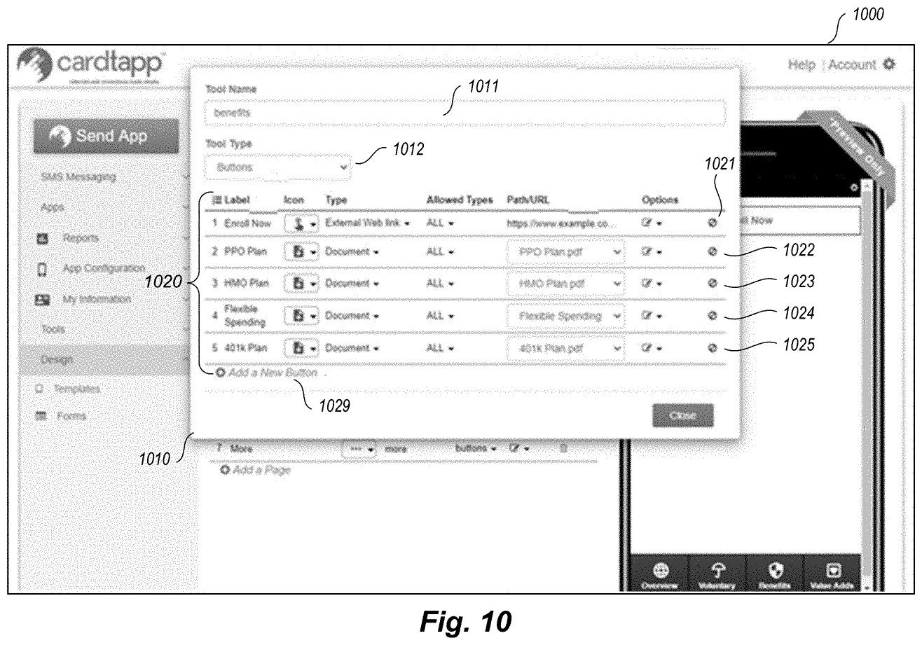

FIG. 10 is a display diagram showing a sample display presented by the facility in some embodiment to add controls such as links or buttons to an app template. The display 1000 shows a popup window 1010, displayed by the facility in response to the user activating the options control in row 942 for the account benefits page shown in FIG. 9. The popup window includes a tool name field 1011 and a tool type selection control 1012 in which the tool type “Buttons” is selected. As a result, the facility has displayed list 1020 of button controls. In the list, each button control has a label, and icon, a type indicating the type of the button's target that is displayed when the button is actuated, an allowed types selection control, a path/URL particularly identifying the target of the button that is displayed when the button is activated, an options specification control, and a hiding control for hiding the button so that it is not displayed in the app. For example, row 1021 shows that an “enroll now” button has an icon of a finger touching a circle, has the external weblink type, has all allowed types, and has a URL that beings with the string “https://www.example.co . . . ”. Row 1022 shows that a PPO plan button has a page icon, is of the type document, has all allowed types, and corresponds to a file system file having file name “PPO Plan.pdf.” The popup also includes a control 1029 that the domain expert can activate to add a new button to the present page.

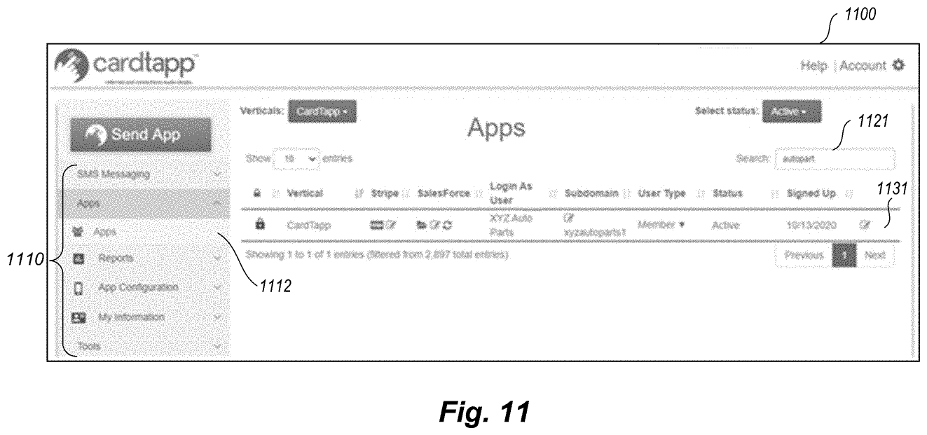

FIGS. 11-14 show a process of customizing the design of a particular mobile app based upon a pre-existing template. FIG. 11 is a display diagram showing a sample display presented by the facility in some embodiments to further customize the design of a mobile app. In the display 1100, the domain expert has clicked on the Apps control 1112 in navigation bar 1110. In response, the facility has displayed a list search field 1121. The domain expert has entered the search string “auto part.” In response, the facility has displayed a list of defined apps in which the search term appears. This list has a single app in it, shown in row 1131. For this app, the facility displays information indicating whether or not the app is locked; a vertical of the app; Stripe controls that operate with respect to the app; SalesForce controls that operate with respect to the app; a user for logging into the app; a subdomain of the app; a user type for the app; a status of the app; and a signed up date for the app. For example 1131 shows that the app is locked, has a vertical of CardTapp, Stripe controls for launching Stripe with respect to the app and editing data maintained in Stripe for the app; sales force controls for opening the app in SalesForce; editing data maintained for the app in SalesForce; updating the connection between the app and its representation in SalesForce; a user “XYZ Auto Parts” to login as; the subdomain “xyzautoparts1”; a user type “Member”; a status of “Active”; a signed up date of Oct. 13, 2020; and a control for editing this information about the app. The domain expert can click on the company name in the “login as user” column in order to update details of the app's configuration.

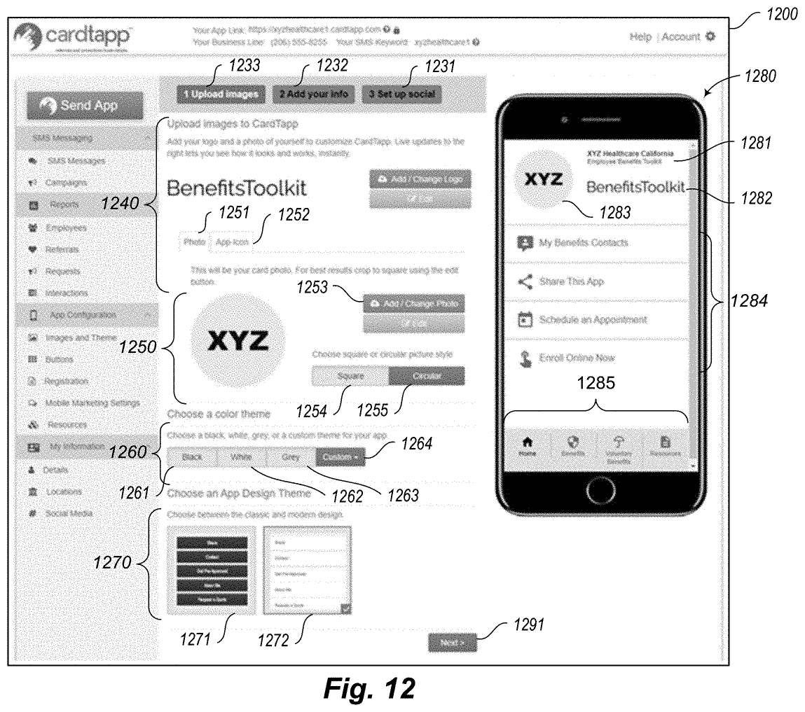

FIG. 12 is a display diagram showing a sample display presented by the facility in some embodiments to enable a domain expert to update details of the configuration of the XYZ Auto Parts app. The display 1200 shows an app configuration process wizard made up of indicators 1231-1233 that show the phases of defining an app. It can be seen that indicator 1233 is presently highlighted, indicating that the app definition process is in the first “Upload Images” phase. As part of that phase, the display includes a logo uploading section 1240 that the domain expert can use to upload an image containing the appropriate logo for the app, as well as an icon specification section 1250 that the domain expert can use to upload an icon for the app, or a photo. Controls 1254 and 1255 can be used to specify whether the image is a square or circle when displayed. A control 1260 enables the domain expert to select a color theme for the app that specifies, for example, the primary color used in the app. The domain expert can also select one of thumbnail images 1271 and 1272 in order to specify an app designed theme for the app. By selecting control 1291, the domain expert can proceed to the next phase of app definition.

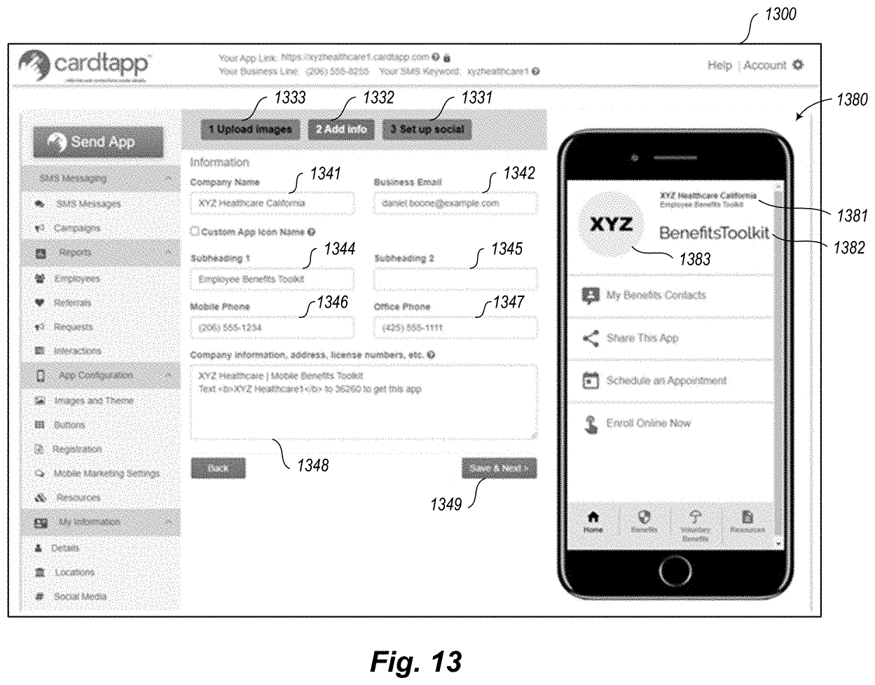

FIG. 13 is a display diagram showing a sample display displayed by the facility in some embodiments to perform the second phase of the app definition process. In the display 1300, it can be seen that status indicator 1332 shows that the second phase of app definition is in progress. In the second phase, the domain expert adds information to be used in the app. In particular, the domain expert can enter information in a company name field 1341, a business email field 1342, a subheading 1 field 1344, a subheading 2 field 1345, a mobile field 1345, an office phone field 1347, and an additional company information field 1348. It can be seen that, in the preview display 1380, the app is displaying company name 1381 as the result of the domain expert entering the same text in field 1341; logo 1382 as the result of specifying that logo in section 1240 shown in FIG. 12; and icon 1383, as the result of selecting the same icon image in section 1250 shown in FIG. 12. The display also includes a control 1349 that the domain expert can activate to proceed to the next phase of the app definition process.

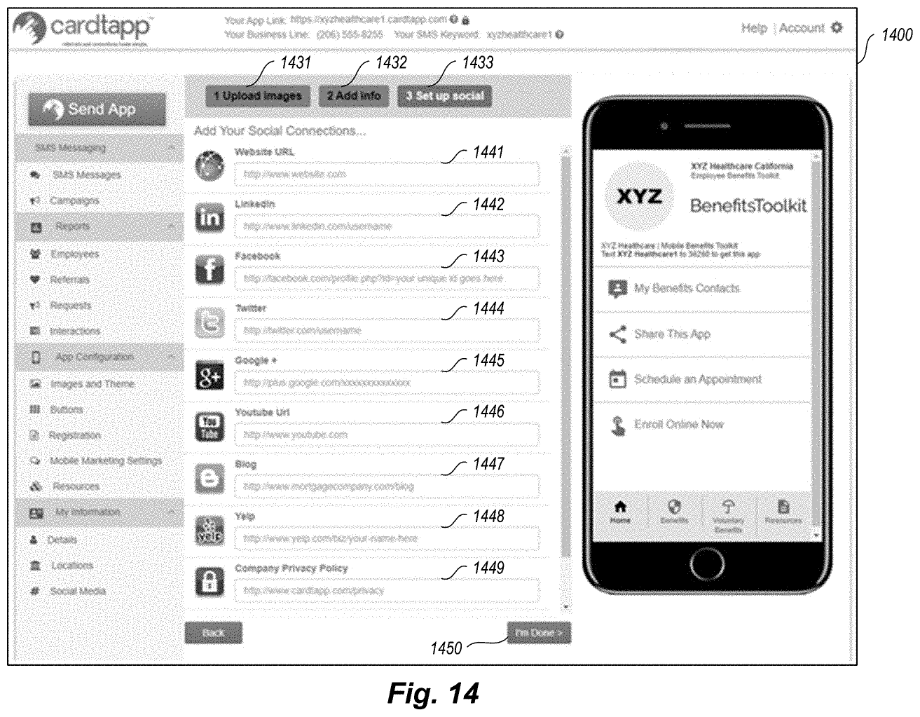

FIG. 14 is a display diagram showing a sample display presented by the facility in some embodiments in connection with the third phase of the app definition process. It can be seen in display 1400 that status indicator 1433 corresponding to the third phase, “Setup social,” is highlighted. In this phase, the domain expert can insert URLs in fields 1441-1449 that point to the company's social media presence on a number of different social media platforms. After doing so, the domain expert can select control 1450 to conclude the app definition process.

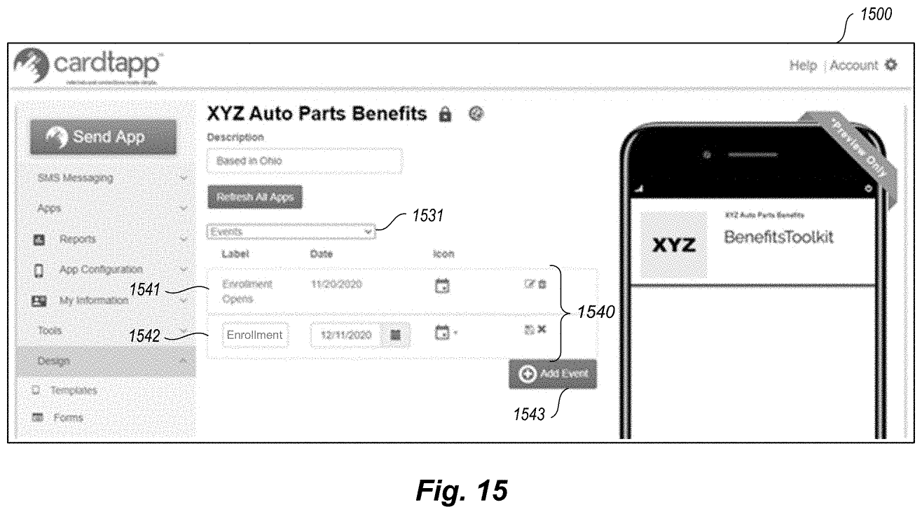

After the main part of the app definition process, the facility can be used to specify (1) events for the app, as well as (2) tracking and analysis to be performed with respect to use of the app by users, such as defining tags and how they are attributed to users based upon the users' behavior, and configuring lead scores for users. The facility's user interface for performing these aspects of app definition are discussed below in connection with FIGS. 15-20.

FIG. 15 is a display diagram showing a sample display presented by the facility in some embodiments to configure events for the app, including such information as beginning and ending dates of an enrollment period, days on which particular communications would be sent to some or all of the users of the app, etc. Display 1500 shows that the domain expert has selected in control 1531 to define event aspects of the app. In this case, the user has displayed a list 1540 of the existing events defined for the app. In particular, the domain expert has already entered an “enrollment opens” event shown in row 1541 for the date of Nov. 28, 2020, and specified an icon for that event. The user has further activated an add event control 1543 to add a second event, and is in the process of entering an enrollment ends event shown in row 1542, which occur on the date Dec. 11, 2020, and for which the domain expert can specify an icon. In some embodiments, as part of the definition of events, the domain expert can use the facility to define campaign events, such as the following:
1. Enrollment Open Msg—This is the initial Campaign that will inform users their enrollment period has begun and how long it lasts;
2. Follow up—This is scheduled 3 days after Enrollment start date and is only targeted towards users that have not engaged with the app to this point; and
3. Close Date Warning—This is scheduled 2 days before enrollment closes to warn people that have not engaged or not enrolled.

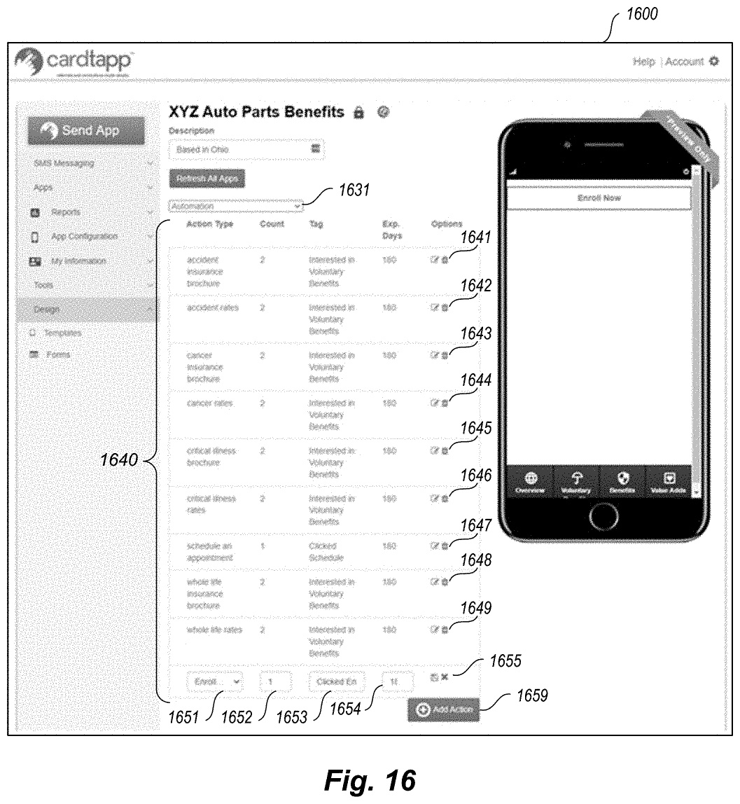

FIG. 16 is a display diagram showing a sample display presented by the facility in some embodiments to enable a domain expert to specify tag definitions for users of the app. The facility then uses the tag definitions specified by the domain expert to determine, for each user, which tags should be attributed to the user to indicate that they have engaged in a pattern of behavior with respect to the app corresponding to the tag and its definition. It can be seen in display 1600 that the domain expert has selected the “Automation” aspect of app definition in navigation control 1631. In response, the facility has displayed list 1640 of existing tags and their definitions. For each listed tag, the tag's row shows a type of action that a user must perform in order to qualify for the tag; a number of times the user must perform this action in order to qualify for the tag; the tag's name; the number of days after the user qualified for the tag that the tag will remain attributed to the user; and controls for editing or deleting a row corresponding to a tag. For example, row 1641 shows that in order to qualify an “interested in voluntary benefits” event, a user must perform an action of accessing an accident insurance brochure within the app twice. When the user does so, they will be assigned the “interested in voluntary benefits” tag, and retain it for 180 days. At the time captured in the diagram, the domain expert is in the process of creating row 1655 by specifying the information needed by the facility for an additional tag. The domain expert can select the floppy disk icon to save the row containing the specified information.

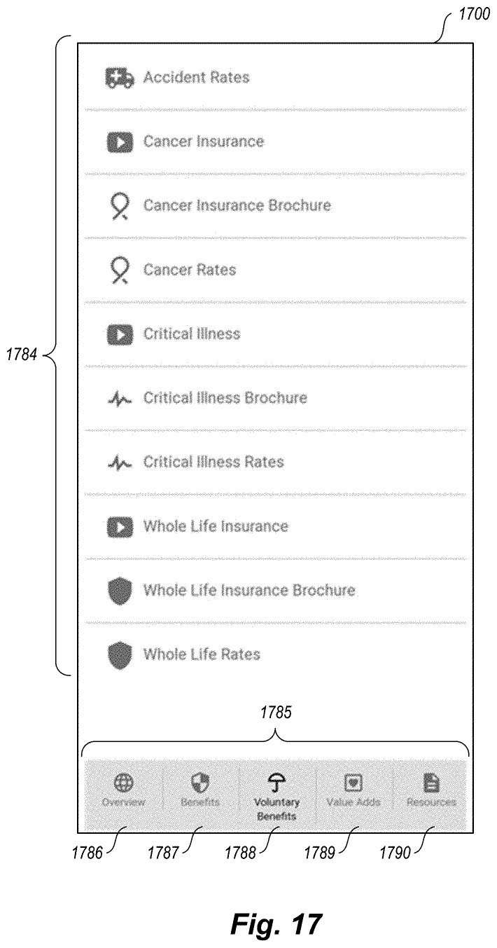

FIG. 17 is a display diagram showing a sample display presented by the facility in some embodiments as part of the execution of the app whose definition is discussed above. In particular, the facility causes display 1700 to be displayed by a smartphone or other mobile device on which the app is installed. The display includes a number of different button controls 1784 that are displayed as part of a “voluntary benefits” page specified for the app. In navigation bar 1785, it can be seen that icon 1788 for this voluntary benefits page is selected. The user can touch or otherwise activate controls 1786, 1787, 1789, or 1790 to navigate to the following pages respectively: overview, benefits, value adds, and resources.

As an example of the facility's automatic application of the tag definitions discussed above in connection with FIG. 16, consider the following sequence of user interactions with respect to display 1700:
1. The user, Jesse James, installs the app on his phone;
2. Jesse opens the app by tapping on the icon on the home screen of his phone;
3. Jesse then navigates to a page of the app called “Voluntary Benefits”;
4. Jesse taps on buttons that interest him;
5. Each time Jesse taps on a button, the interaction is recorded in the database including which button he tapped on;
6. Jesse is particularly interested in the content he sees when he taps on the button labeled “Whole Life Rates”. He taps on that button a second time to take another look at that content;
7. Jesse has now recorded two taps on that button so the interaction count is incremented and a new total of 2 is calculated and saved; and
8. The tag automation rule for that button has the count set to 2. At the same time that the count total of 2 is saved for Jesse, the tag called “Interested in Voluntary Benefits” is added to Jesse's employee record in the database.

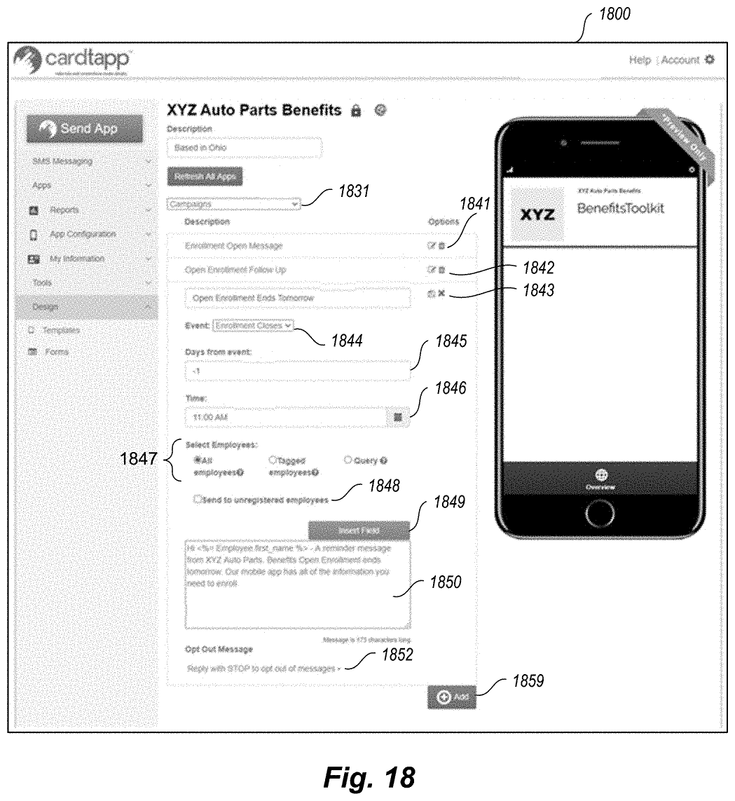

FIG. 18 is a display diagram showing a sample display presented by the facility in some embodiments to enable the creation of a text messaging, or “SMS”, campaign for the app. In the display 1800, the domain expert has selected a “campaigns” aspect of app definition in control 1831. As a result, the facility has displayed a list of campaigns. In the list, row 1841 corresponds to an existing enrollment open message campaign. Row 1842 corresponds to an open enrollment follow-up campaign. Row 1843 is in the process of creation, and corresponds to an “open enrollment ends tomorrow” campaign. In control 1844, the domain expert selects one of the events defined for the app using the process discussed above in connection with FIG. 15, here an “enrollment closes” event. In field 1845, the domain expert enters a directional time interval with respect to the event specified with control 1844, here one day before the enrollment closes event occur. In field 1846, the domain expert enters a time on this day at which the campaign's communication is to be communicated to users of the app. In control 1847, the domain expert can select the set of users to which the campaign's communication is to be sent. Here, the domain expert uses a control to specify that the communication is to be sent to all users of the app. Alternatives are that communication is to be sent only to app users to whom a particular tag has been attributed, or app users that satisfy a particular ad hoc query specified as part of the process of creating this campaign. The domain expert can use control 1848 to specify whether the communication is to be sent to employees that have not yet registered to use the app. The domain expert then enters contents for the message in field 1850. As part of this process, the domain expert can activate an insert field control 1849 to insert in the message a variable that a facility will substitute with the corresponding value for each user, such as the user's first name, as shown in the first line of the message. The domain expert can also use control 1852 to specify, as part of the campaign, how the user can opt out of future messages. The user activated control 1859 to begin the process of creating new row 1843 for the enrollment ends tomorrow campaign.

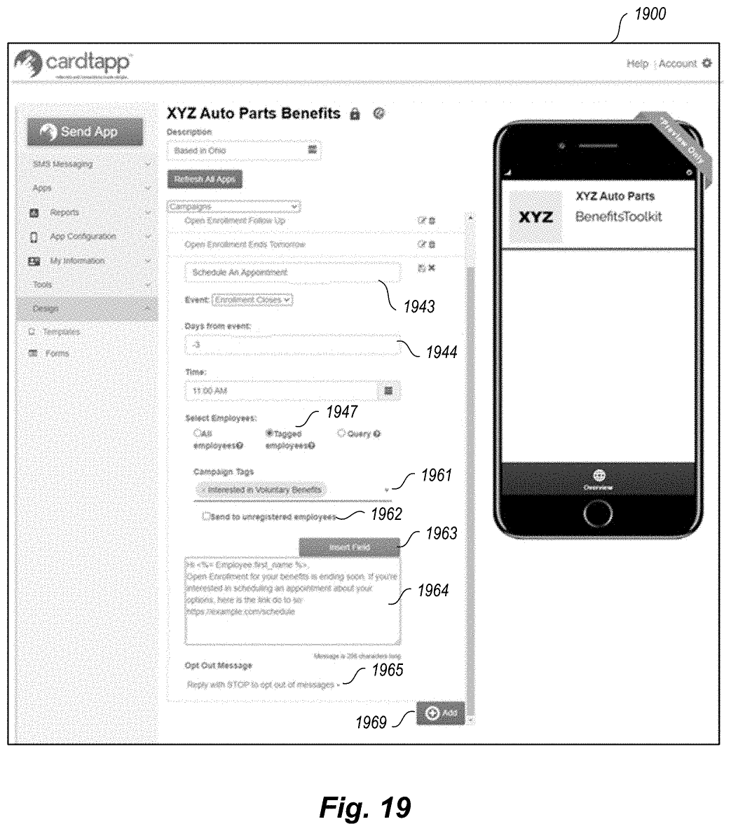

FIG. 19 is a display diagram showing a sample display presented by the facility in some embodiments in order to permit a domain user to specify a campaign limited to users to whom a certain tag has been attributed. In display 1900, it can be seen that the domain expert is editing a row for a “schedule an appointment” campaign, for which a message will be sent to some users at 11:00 am on the date that is three days before the “enrollment closes” event. The domain expert has used control 1947 to specify that the message for this campaign will be sent to only users to whom a particular tag has been attributed. The domain expert has used control 1961 to select the tag “interested in voluntary benefits” as the one the user must have to receive the message for the campaign; this tag was earlier defined, and is shown in row 1649 appearing in FIG. 16. In a manner similar to that discussed above in connection with FIG. 18, the domain expert enters the message and auto message for this campaign, which will be sent to only those users, such as Jessie James, whose actions have qualified them to have the interested in voluntary benefits tag.

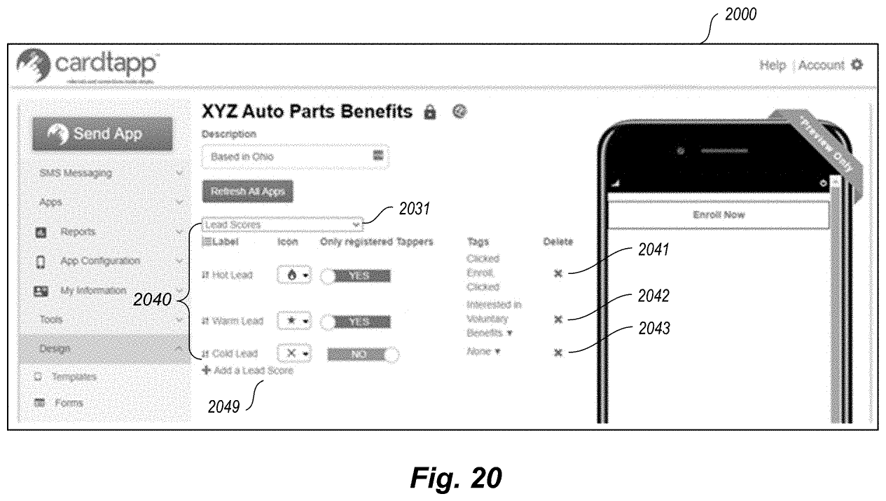

FIG. 20 is a display diagram showing a sample display presented by the facility in some embodiments to specify how lead scores are determined for each user of the app. In the display 2000, the domain expert has selected a lead scores aspect of app definition in navigation control 2031. As a result, list 2040 of lead scores, also known as “lead labels,” is displayed. Each row on the list corresponds to a different lead score, and specifies how a user qualifies for that lead score. For example, row 2041 shows that a user qualifies for the lead score “hot lead” with an icon of a flame, if they are a registered user, if they have the following tags: “clicked enroll,” and “clicked schedule.” Row 2042 shows that a user can qualify as a warm lead, indicated by a smaller flame icon, if they are a registered user who has qualified for the “interested in voluntary benefits” tag. Row 2043 shows that a registered user qualifies as a cold lead, having an “X” icon, if they do not satisfy the requirements of the lead shown above. In some embodiments, the facility applies the lead score definitions in the order they appear in the list, such that a lead score is assigned to a user for the first lead score definition that the user satisfies. The facility enables the domain expert to reorder the rows, so that the lead score definitions are applied in a different order. The domain expert can select control 2049 to add another lead score.

After the domain expert uses the facility to define an app, the facility directs them to schedule publication dates, upload a list of prospective app users and their contact information, and launch the app. A company or other user group may have many different enrollment periods based upon how much the group is aligned, and may also have periodic enrollment periods throughout the year for new hires. There may be a different enrollment period for each state, county, division, group, etc. In many cases, the content remains the same across these different groups within the same company or organization.

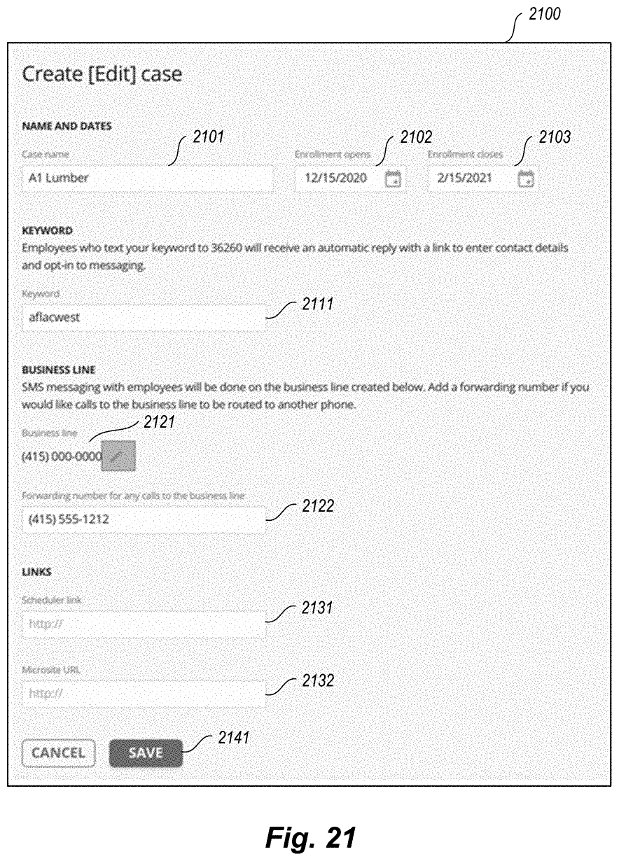

FIG. 21 is a display diagram showing a sample display presented by the facility in some embodiments to further define the app. In display 2100, the facility includes a field 2101 for specifying a case name for the app release, as well as enrollment opening and closing dates in fields 2102 and 2103. The display includes a field 2111 into which can be entered a key word that prospective users can text to the facility to receive a text response that will enable them to enter contact details and opt into messaging from the facility. The display includes fields for specifying phone numbers at which to receive SMS responses from prospective users, and phone calls relating to use of the app. The display further includes links for a scheduler and a microsite corresponding to the app. The domain expert selects a save control 2141 to save the information entered.

The facility also solicits from the domain expert information about each prospective user of the app. In some embodiments, this includes at least the prospective user's name and mobile phone number. In various embodiments, this information can include various other information about each prospective user.

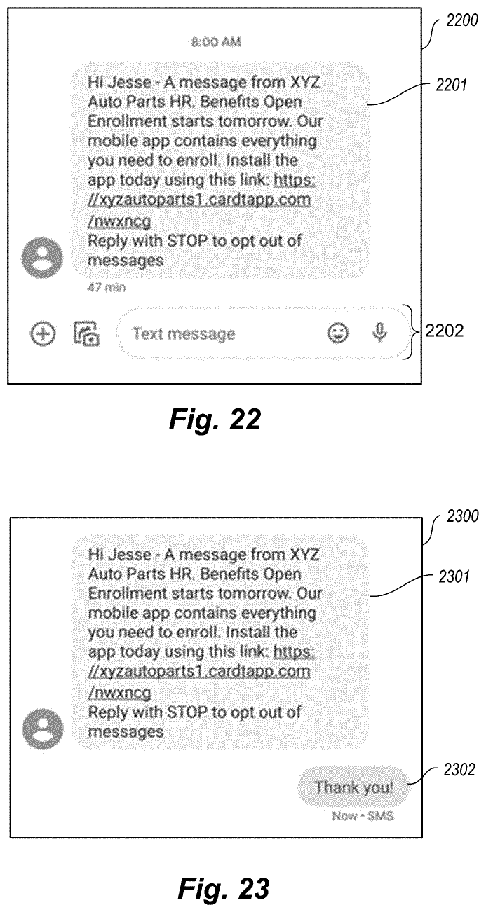

FIG. 22 is a display diagram showing a sample SMS message sent to each prospective user of a particular app. The display 2200 includes the message, which includes a link that can be used to install the app, as well as opt out instructions for future text messages from the facility. The prospective user who receives this message can click on the link in order to install and register for the app. They may also use response controls 2202 to create and send a response to the facility's message. One possible response is the opt out keyword “stop” specified in the facility's message.

FIG. 23 is a display diagram showing a sample display in which the prospective user has used the response controls to send an SMS reply to the facility's solicitation message. It can be seen in display 2300 that this reply message 2302 is “thank you!”. The facility receives this response for display to an agent working in connection with the app.

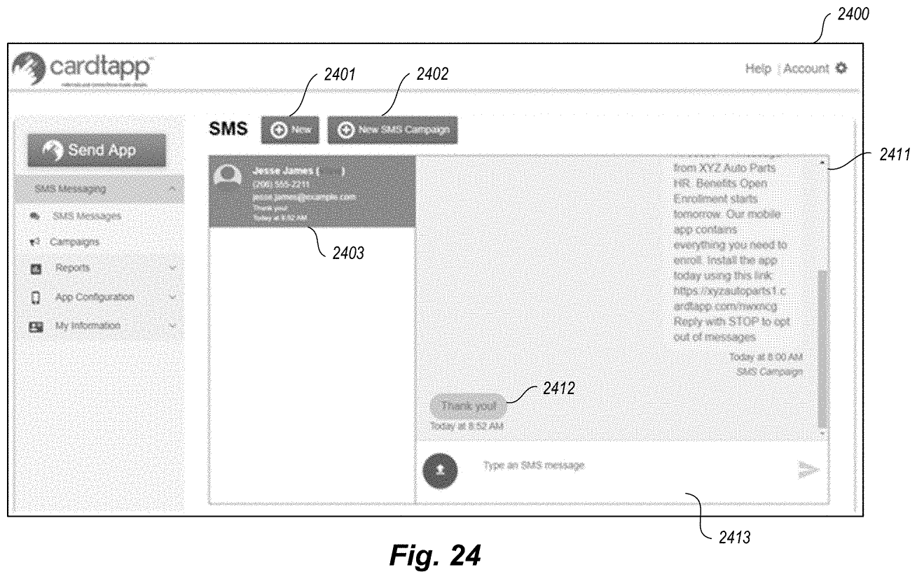

FIG. 24 is a display diagram showing a sample display presented by the facility in some embodiments to permit an agent working in connection with the facility to correspond with users and prospective users of the app. The display 2400 shows identifying information 2403 for the user or prospective user from whom SMS messages have been received. The message window 2411 includes the original message sent to the user by the facility, as well as the user's or prospective user's response 2412. The agent can enter a new message in response field 2413 for transmission to the user. The agent may also activate a new control 2401 to create a new message to a user, or a control 2402 to create a new campaign.

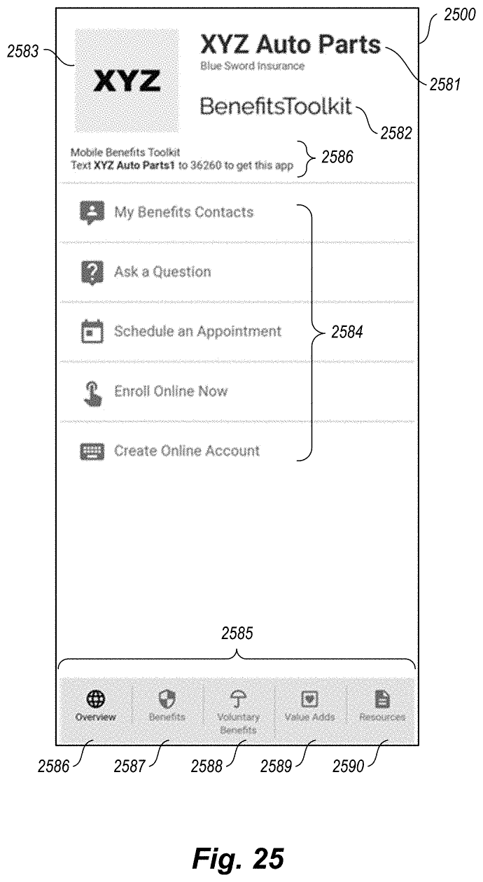

FIG. 25 is a display diagram showing a sample display presented by the facility in some embodiments as part of the execution of the app on the device of an enrolled user. The display 2500 is for an overview page, as indicated by highlighting of the overview page indicator 2586 in navigation bar 2585. The display includes group name 2581, app name 2582, and app icon 2583 specified during the template and app definition process. It further includes button controls 2584 specified for the overview page during the template and app definition process. The user can select any of these buttons in order to display additional information within the app, such as a different page of the app or a document populated into the app. In some embodiments, the user can select buttons or other controls in the app to elect or decline particular forms of coverage or other benefits. The display also includes a message 2586 indicating how those who have not received, installed, or registered for the app can do so. All of the user's interactions with the buttons and controls on this page and other pages of the app are recorded, and used by the facility as basis for determining which tags to attribute to each user. The user may also navigate to other pages of the app using the page indicators 2587-2590 in navigation bar 2585.

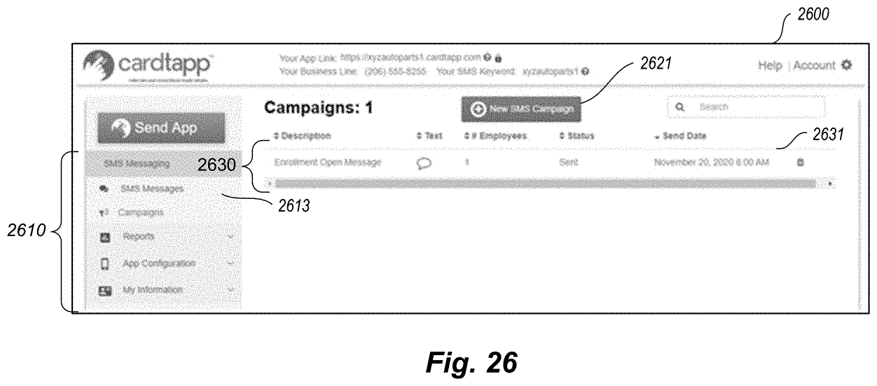

FIG. 26 is a display diagram showing a sample display presented by the facility in some embodiments to schedule an ad hoc SMS campaign. This can be done at any time to communicate important information related to the benefits enrollment process. The display 2600 includes application control 2613 in navigation bar 2610 that the domain expert can select in order to navigate to the SMS message campaign section. This causes the app to display list 2630 of campaigns defined for the app. The list includes a single campaign represented in the list by row 2631 for the enrollment open message campaign. It shows that a text message has been sent for this campaign to one prospective user at 8:00 a.m. on Nov. 20, 2020. The domain expert can select 2621 to create a new campaign to be added to the list. In response, the facility displays a new page relating to the creation for the new campaign.

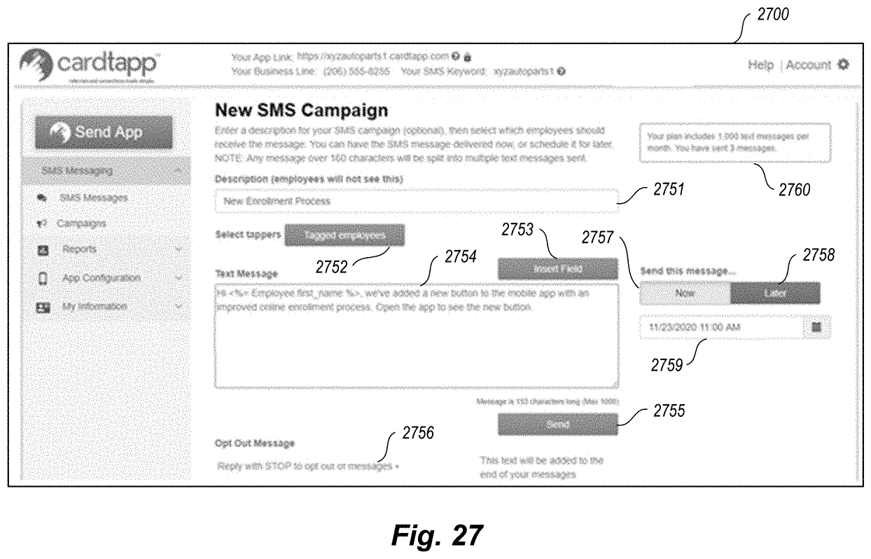

FIG. 27 is a display diagram showing a sample display presented by the facility in some embodiments to specify information for a new campaign. The display 2800 includes a field 2751 into which domain expert enters a name description for the campaign, which will not be seen by app users. The domain expert can select a control 2752 to specify which users will receive the campaign's message. In response to activation of control 2752, the facility displays a popup window.

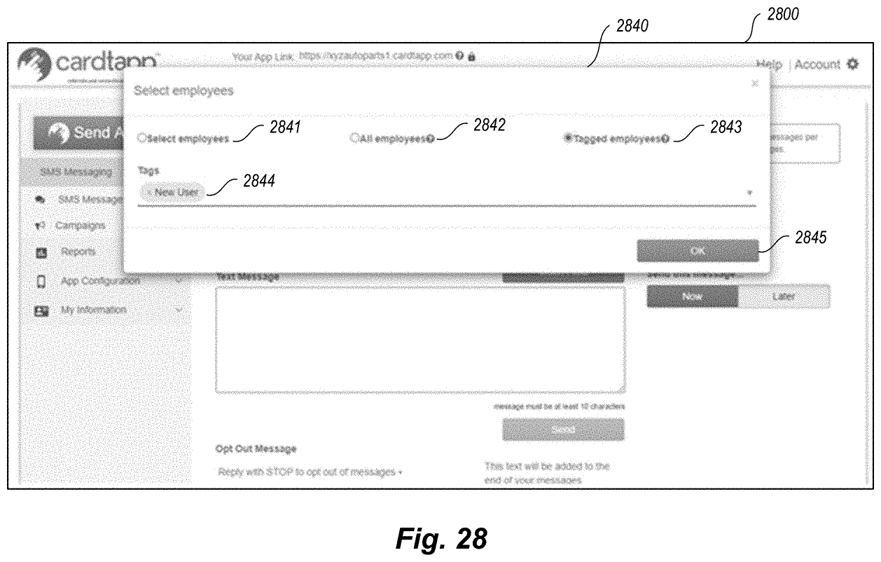

FIG. 28 is a display diagram showing a sample display presented by the facility in some embodiments to present a popup window for specifying the users who will receive a new campaign's message. The popup window 2840 includes a control 2841 that the domain expert can select to manually modify a list of employees to receive the message; a control 2842 the domain expert can select in order to direct the message to all employees; and a control 2843 that the domain expert can select in order to specify that the message be sent to only employees having one or more particular tags. Having selected the tagged employees option, the domain expert enters a list of one or more tags 2844 that a user must have in order to receive the campaign's message. After specifying this information, the domain expert activates an OK control 2845 to save the entered information and dismiss the popup window. Returning to FIG. 27, the domain expert enters the campaign's message in field 2754, using the insert field control 2753 to insert any needed fields that vary by user. The domain expert can also use 2756 to specify a message about how the user can opt out of future message from the facility. The domain expert can use controls 2757 and 2758 to specify whether the message for the campaign should be sent immediately, or at a future date and time, specified using control 2759. The user can activate send control 2755 to finish definition of the campaign. Display 2700 also includes an indication 2760 of how many of an allocated number of SMS message to be sent by the facility have already been sent.

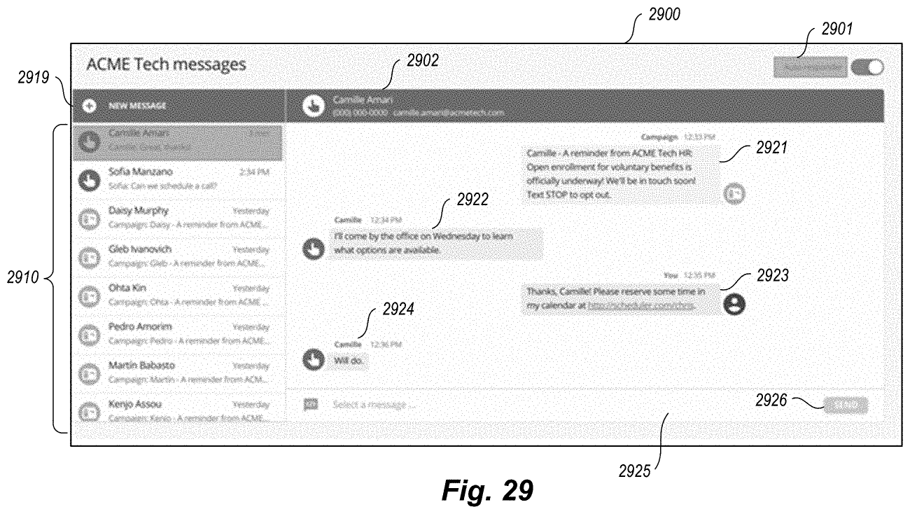

FIG. 29 is a display diagram showing a sample display presented by the facility in some embodiments to provide a dashboard for agents working in connection with the facility. In this dashboard, agents receive texts from app users who have particular interests or questions with respect to the app such as interests or questions about various benefits whose availability is described by the app. In some cases, agents or others will configure the facility to make automated responses to some of these user messages that direct the users who send them to an agent they can talk with on the phone. The display 2900 includes a toggle 2901 that the agent uses to turn automatic responses by the facility on and off. The display also contains a list 2910 of users with whom SMS communication is in progress. In this list, the top user, Camille Amari is selected. Accordingly, information 2901 identifying this user and that is usable to contact her is displayed. Also, a message window contains messages 2921-2924 exchanged with the user. The agent may also type a message in response field 2925 and send it to the user by activating send control 2926.

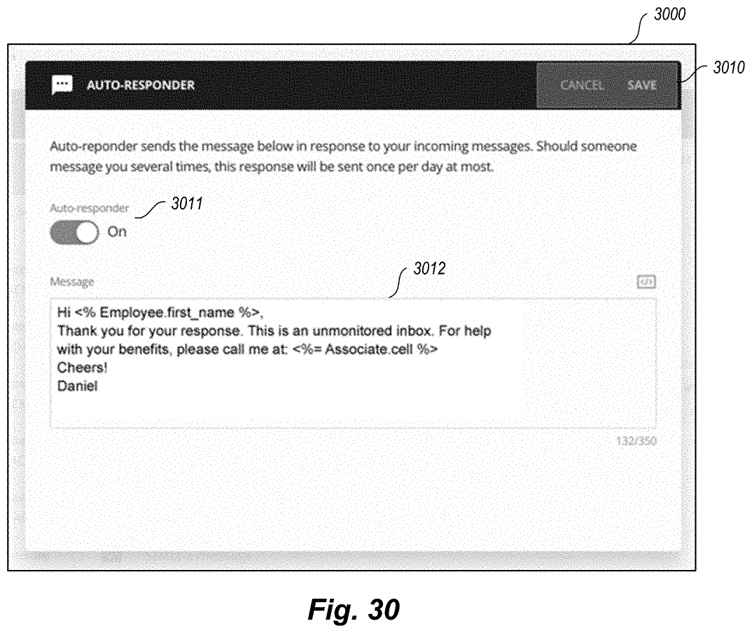

FIG. 30 is a display diagram showing a sample display presented by the facility in some embodiments in order to enable an agent or other person working with respect to the facility to specify an auto responder message to be sent in response to some or all user message received while the auto responder toggle is switched on. The display 3000 includes another toggle 3011 for switching the auto responder on and off and further includes a message contents field 3012 for specifying the contents of the autoresponse message, a save control 3010 can be activated in order to save the information specified in the auto responder.

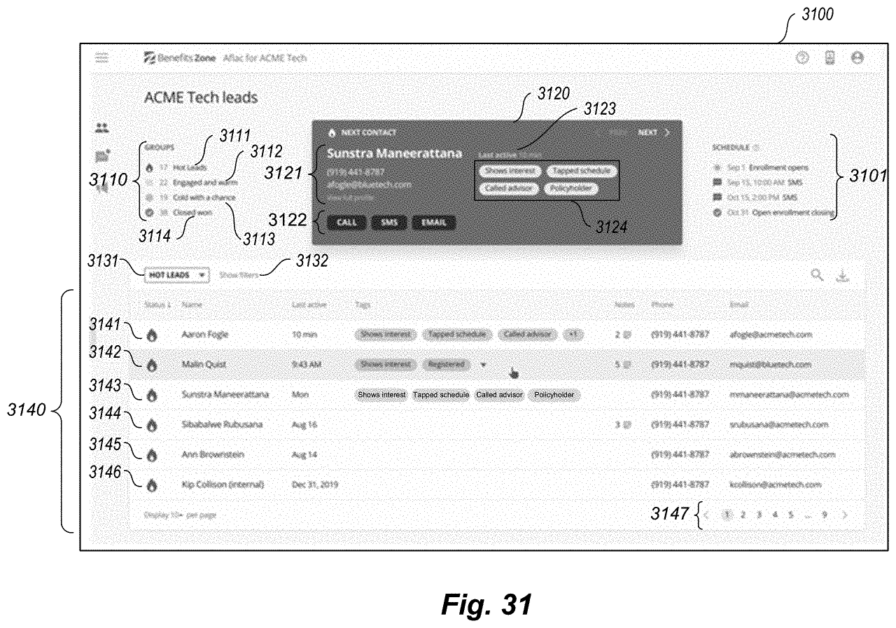

FIG. 31 is a display diagram showing a sample display presented by the facility in some embodiments in order to provide a user evaluation dashboard to an agent, as a basis for the agent taking action to contact or otherwise follow up with particular users. Display 3100 includes a schedule 3101 of the events specified for the campaign. The display 3100 also includes overview 3110 of the users having each lead score: a count 3111 of users having the “hot lead” lead score; a count 3112 of the users having the “engaged and warm” lead score; a count 3113 of the users having a “cold with a chance” lead score; and a count 3114 of the users who have successfully completed their use of the app, such as by electing or declining a certain set of benefits. It further includes a control 3131 that can be used to select the lead scores in order to display all of the user who have qualified for this lead score. The agent may also activate control 3132 to display list of additional filters for limiting the set of users of the app corresponding to list 3140. Here, the agent has selected the “hot leads” lead score, and accordingly the list of displayed users are only those users who have received this lead score based upon their interactions of the app. A portion 3140 of this list of users is presently shown, while a navigation control 3147 allows the agent to scroll to other portions of the selected list of users. As one example, row 3142 of the list shows that user Mailin Quist has the “hot lead” lead score, was last active at 9:43 a.m., has the “shows interest” and “registered” tags, has five notes which can be displayed, has a phone number of “919 441 8787,” and an email of “mquist@bluetech.com.” The user can select one of these rows to display additional information about a single user. For example, in display 3100 the agent has selected row 3143, corresponding to the user Sunstra Maneerattana. In response, the facility has displayed information 3120 about this user, which includes the tags 3124 attributed to the user, controls 3122 for contacting the user, and identifying and contact information 3121 for the user. The agent can use navigation controls in this box to navigate to other users in the list. The agent may use this dashboard, for example, to contact all or some of the users having a certain lead score or satisfying a larger set of criteria, such as by phone, SMS, or email. They can make choices about doing this based upon the lead score, last active time, attribute tags, notes, or earlier correspondence between the user and an agent, etc.

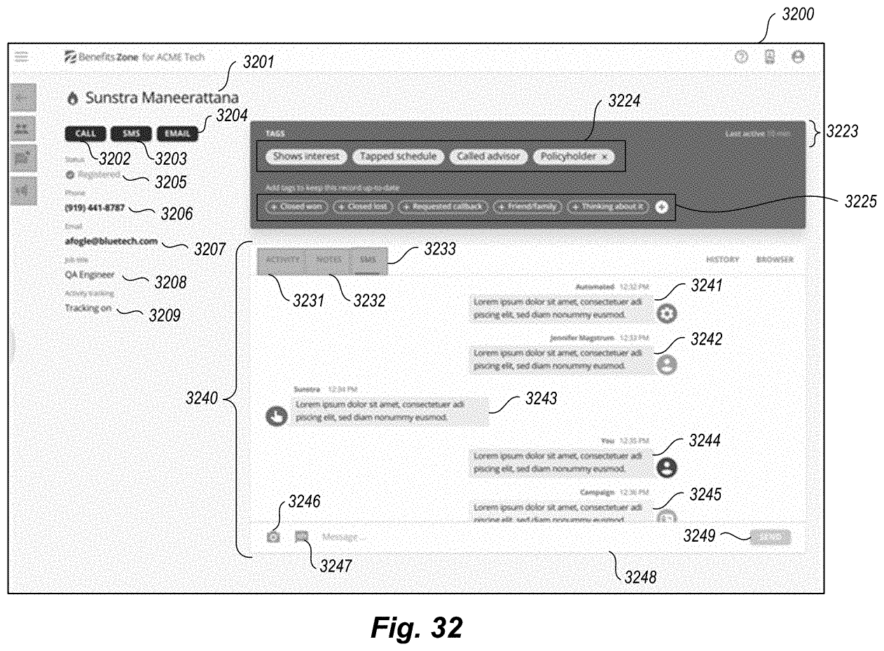

FIG. 32 is a display diagram showing a sample display presented by the facility in some embodiments to examine in more detail the information about a particular user. As shown by indication 3201, this display 3200 relates to the user “Sunstra Maneerattana.” In various embodiments, the agent reaches this display by selecting certain information related to this user that is shown in display 3200, such as by double clicking on the user's row in the list, selecting a specialized control in additional information box 3120, etc. The display 3100 includes controls 3202-3204 for calling, sending a text message to, and emailing this user. The display further includes an indication 3205 of the user's registration status, indication 3206 of the user's phone number, indication 3207 of the user's email address, indication 3208 of the user's job title, and indication 3209 about whether tracking of the user by the facility is enabled. The display 3200 also includes a communications record section 3240 in which the agent can display the records the facility maintains of earlier communications with this user. In this display, an SMS tab 3233 is selected, such that this section of the display contains SMS message 3241-3245 exchanged with the user. In this pane, the agent can use response controls 3246-3249 to send one more additional SMS messages to the user. The agent can also select an activity tag 3231 to show a list of the interactions the user has had with the app, or notes tab to show notes recorded about the user, such as by this agent or a different agent.

The display 3200 also contains an indication 3223 of when the user was last active; tags attributed to the user, which in some embodiments can be removed by the agent if the agent finds them to be inappropriate for the user; and a list 3225 of tags that the agent can manually add for the user. For example, an agent may add a tag for a user based upon certain communications that the agent has had with the user.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system for operating a distributed mobile app, the method comprising:
presenting a user interface;
receiving via the user interface input selecting an app template;
accessing app configuration settings specified by the selected app template;
receiving via the user interface input adjusting the accessed app configuration settings;
configuring the distributed mobile app in accordance with the adjusted app configuration settings;
receiving contact information for each of a set of people;
for each person of the set, causing a communication containing a link to install the configured distributed mobile app to be transmitted using the received contact information;
for a subset of the set of people, presenting in the user interface information describing the person's use of the app;
for a distinguished person of the set, receiving input via the user interface in connection with the presented information describing the distinguished person's use of the app directing that the distinguished person be contacted in connection with the distinguished person's use of the app; and
in response to the input directing that the distinguished person be contacted in connection with the distinguished person's use of the app, causing the distinguished person to be contacted in connection with the distinguished person's use of the app.

2. The method of claim 1 wherein the distributed mobile app is configured in accordance with adjusted app configuration settings that adjust the accessing app configuration settings by adding a configuration setting not present among the accessing app configuration settings.

3. The method of claim 1 wherein the distributed mobile app is configured in accordance with adjusted app configuration settings that adjust the accessing app configuration settings by changing a configuration setting present among the accessing app configuration settings.

4. The method of claim 1 wherein the received user interface input adjusting the accessed app configuration settings establishes a name for the distributed mobile app.

5. The method of claim 1 wherein the received user interface input adjusting the accessed app configuration settings establishes an image to be displayed by the distributed mobile app.

6. The method of claim 1 wherein the received user interface input adjusting the accessed app configuration settings specifies a document to be accessible in the distributed mobile app.

7. The method of claim 1 wherein the received user interface input adjusting the accessed app configuration settings specifies a user interface control to be provided in the distributed mobile app.

8. The method of claim 1, further comprising:
for each person of the subset:
receiving data from an instance of the app executing on behalf of the person reflecting actions taken with respect to the app; and
storing indications of the actions reflected by the received data in connection on behalf of the person.

9. The method of claim 8, further comprising:
for each person of the subset:
for each of a plurality of tags each having a definition:
determining whether the action indications stored for the person satisfy the tag's definition; and
where the action indications stored for the person satisfy the tag's definition, attributing the tag to the person,
wherein the information presented describing each person's use of the app identifies tags attributed to the person.

10. The method of claim 8, further comprising:
for each person of the subset:
determining a score for the person based on the action indications stored for the person.

11. The method of claim 1 wherein the distinguished person is caused to be contacted via SMS message, email message, in-app message, or voice call.

12. One or more memories collectively containing a data structure representing the state of a distributed mobile app, the data structure comprising:
first data identifying configuration options specified for configuring the distributed mobile app; and
second data indicating, for each of a plurality of users of the distributed mobile app, actions taken by the user with respect to the distributed mobile app.

13. The one or more memories of claim 12, the data structure further comprising:
for each of the plurality of users of the distributed mobile app, contact information usable to contact the user of the distributed mobile app.

14. The one or more memories of claim 12, the data structure further comprising:
third data indicating, for each of the plurality of users of the distributed mobile app, for each of a plurality of user tags, whether the second data indicates that the user of the distributed mobile app took actions with respect to the distributed mobile app that qualify the user of the distributed mobile app for the user tag.

15. The one or more memories of claim 14 wherein the first data comprises, for each of the plurality of user tags, data encoding a test whose satisfaction by the second data for a distinguished user of the distributed mobile act qualifies the distinguished user for the user tag.

16. One or more memories collectively having contents configured to cause a mobile computing device to perform a method for operating a distributed application, the method comprising:
associating the mobile computing device with a distinguished user;
presenting a sequence of visual displays on a display component of the mobile computing device, the presentation based at least in part on a set of configuration settings, a subset of the set of configuration settings received from a person other than distinguished user on behalf of a group of users that includes the distinguished user, at least a portion of the visual displays providing an opportunity for user interaction with the distributed application;
tracking the distinguished user's interactions with the distributed application; and
reporting the tracked interactions with the distributed application to a server as a basis for assessing the distinguished user's interactions with the distributed application on the server.

17. The one or more memories of claim 16 wherein the subset of the set of configuration settings received from a person other than distinguished user on behalf of the group of users that includes the distinguished user were received from the person other than distinguished user in the context of configuration settings specified in an application configuration template selected by the person other than distinguished user.

18. The one or more memories of claim 16 wherein at least one of the visual displays of the sequence comprises an image specified among the set of configuration settings.

19. The one or more memories of claim 16 wherein at least one of the visual displays of the sequence comprises contents of a document specified among the set of configuration settings.

20. The one or more memories of claim 16 wherein at least one of the visual displays of the sequence comprises a user interface control specified among the set of configuration settings.
